(19) United States
(12) Patent Application Publication
(10) Pub. No.: US 2014/0056414 A1
(43) Pub. Date: Feb. 27, 2014

(54) X-RAY WAVEGUIDE AND X-RAY MEASUREMENT SYSTEM

(71) Applicant: Canon Kabushiki Kaisha, Tokyo (JP)

(72) Inventors: Atsushi Komoto, Moriya-shi (JP); Kohei Okamoto, Yokohama-shi (JP)

(21) Appl. No.: 13/971,322

(22) Filed: Aug. 20, 2013

(30) Foreign Application Priority Data
Aug. 21, 2012 (JP) 2012-182266

(51) Int. Cl. G21K 1/06

(52) U.S. Cl. CPC G21K 1/062
USPC 378/145

(57) ABSTRACT

An X-ray waveguide having a curved structure formed of a core and two claddings that sandwich the core and are mutually opposed, wherein when a y-axis is defined using as an origin a center of a circle, which defines a curvature radius of an interface a between a cladding A present on an inner circumference side of the curved structure of the two claddings, and the core, perpendicular to a tangent at an arbitrary point S and in a direction from the origin toward the interface b, a refractive index real part of the core in the interface a at a y₀ is larger than a refractive index real part of the core in the interface b at a y₁, and the refractive indexes become equal or larger as the y is increased.

### BACKGROUND OF THE INVENTION

1. Field of the Invention

The present invention relates to an X-ray waveguide that guides an X-ray, particularly an X-ray waveguide having a curved structure, and an X-ray measurement system.

2. Description of the Related Art

When an electromagnetic wave having a short wavelength of several tens nm or less is handled, a difference of refractive index real parts for the electromagnetic wave between different substances is 10⁻⁴ or less that is very small, and thus a total reflection critical angle also becomes very small. Thus, in order to control the electromagnetic waves including an X-ray, a large-scale space optical system has been used which is still a mainstream. For example, polycapillary and the like are used as an element for propagating the X-ray and controlling a beam shape.

Contrary to the space optical system that is the mainstream, an X-ray waveguide which traps and propagates the electromagnetic wave in a core surrounded with a cladding material has been studied. Specifically, a thin film waveguide having a one-dimensional confinement structure in which a core layer is sandwiched with cladding layers, and an X-ray waveguide having a two-dimensional confinement structure in which a fibered core penetrates a cladding material have been studied. Unlike the polycapillary, a cross-sectional area where the X-ray is guided is very small in the X-ray waveguide. Thus, it is possible to provide an X-ray beam having a spatial coherence in which a phase of the X-ray is controlled in a cross-section of the waveguide. Due to its feature, the X-ray waveguide is often used as an element that provides an X-ray source for performing holography with the X-ray. To perform off-axis holography that is one form of the holography, two X-ray beams that are both coherent are required. C. Fuhse, C. Ollinger, et al., “Waveguide-based off-axis holography with hard x-rays.”, Physical Review Letters 97 254801 (2006) and C. Fuhse, “X-ray waveguides and waveguide-based lensless imaging”, Ph. D thesis (2006) have disclosed a curved X-ray waveguide (hereinafter curved X-ray waveguide) that can curve the X-ray to provide such X-ray beams.

However, a curvature radius of the X-ray waveguide cannot be reduced in such a curved X-ray waveguide. Thus, a deflection angle of the X-ray is restricted maximally to 2°. This is because in order to increase the deflection angle, a length of the curved X-ray waveguide needs to be lengthened to 3 mm or more since the curvature radius is small, which increases loss of guided X-ray.

### SUMMARY OF THE INVENTION

The present invention is directed to an X-ray waveguide and an X-ray measurement system, where a waveguide loss of an X-ray in a curved X-ray waveguide is reduced.

According to an aspect of the present invention, an X-ray waveguide has a curved structure formed of a core and two claddings that sandwich the core and are mutually opposed, wherein when a y-axis is defined using as an origin a center of a circle, which defines a curvature radius of an interface between a cladding A present on an inner circumference side of the curved structure of the two claddings and the core, in a direction perpendicular to a tangent at an arbitrary point S on the interface and in a direction from the origin toward the interface, as to any y that satisfies a following formula (7), a refractive index real part n(y) of the core satisfies following formulae (5) and (6):

ñ(y₀)>ñ(y₁) Formula (5)

ñ(y₀)≧ñ(y)≧ñ(y₁) Formula (6)

y₀<y<y₁ Formula (7)

wherein in Formula (5), y₀ is a y-coordinate of the interface between the core and the cladding A, and y₁ is a y-coordinate of the interface between the core and a cladding B present on an outer circumference side of the two claddings, and n(y₀) denotes a refractive index real part of the core at the y₀, and n(y₁) denotes a refractive index real part of the core at the y₁.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view illustrating an X-ray waveguide having a curved structure of the present embodiment.

FIG. 2A is a view illustrating an approximated refractive index distribution of an X-ray waveguide having a conventional curved structure and a refractive index distribution of a conventional X-ray waveguide having no curved structure. FIG. 2B is a view illustrating an approximated refractive index distribution of an X-ray waveguide having a curved structure of the present embodiment and a refractive index distribution of a conventional X-ray waveguide having no curved structure.

FIG. 3 is a view showing examples of the present invention when a region size of a small portion of a refractive index real part is changed.

FIG. 4 is a view showing an X-ray system or apparatus of the present embodiment.

FIGS. 5A-5D are views illustrating a first Example.

FIG. 6 is a view illustrating relation of a curvature radius y₀, a length of a curved X-ray waveguide L, and a deflection angle α_{d}.

FIGS. 7A-7D are views illustrating a second Example.

FIGS. 8A-8D are views illustrating a third Example.

### DESCRIPTION OF THE EMBODIMENTS

Various exemplary embodiments, features, and aspects of the invention will be described in detail below with reference to the drawings.

First, terms used herein will be described below.

### (X-Ray)

An X-ray is an electromagnetic wave in a wavelength zone in which a refractive index real part of a substance (core material and the like) is 1 or less, and specifically the X-ray herein refers to the electromagnetic wave with a wavelength of 100 nm or less including extreme-ultraviolet (EUV) light.

A frequency of the electromagnetic wave having such a short wavelength is very high and an outermost electron in a substance cannot be responsive. Thus, such an electromagnetic wave exhibits a nature different from electromagnetic waves (visible light and infrared ray) in a frequency zone having wavelength equal to or longer than ultraviolet light. For example, as described above, it is known that the refractive index real part in most substances is less than 1 for the X-ray.

The refractive index n of a substance for such an X-ray is represented using an amount of deviation from 1 of the real part and β of imaginary part related to absorption as generally represented by a following formula (1):

n=1−δ−iβ Formula (1)

The refractive index real part is represented by a following formula (2):

ñ=1−δ Formula (2)

As described above, the refractive index of the substance for the X-ray is represented by a complex number. Its real part is referred to as the refractive index real part or the real part of the refractive index, and its imaginary part is referred to as the refractive index imaginary part or the imaginary part of the refractive index in the present invention and herein.

In the wavelength zone of the X-ray, a substance having the maximum refractive index real part of 1 is vacuum, and gaseous matter as typified by air has almost the same refractive index as the vacuum, but the refractive index real part of almost all substances other than the gases is less than 1. Those represented by the “substance” “component” and “material” in the present invention and the present specification include not only those having a shape such as solids but also the vacuum and the gas such as the air.

The refractive index real part of the substance for the X-ray can be calculated based on a composition of elements that compose the substance using a following formula (3):

$$: \tilde{n} = 1 - δ = 1 - \frac{{r}_{e} {λ}^{2}}{2 π} {\sum }_{i} {N}_{i} {\tilde{f}}_{i} \qquad Formula ( 3 )$$

Here, rₑ: classical electron radius, λ: wavelength of X-ray, Nᵢ: number of atoms per unit area of the i-th element that composes the substance, and fi: real part of atomic scattering factor of the i-th element that composes the substance.

$${\sum }_{i} {N}_{i} {\tilde{f}}_{i}$$

The formula (4) shown within the formula (3) means a total sum of values obtained by multiplying the number of atoms per unit area of each element by the real part of the atomic scattering factor of the element.

In the present invention and specification, based on the composition distribution of each element of the core, which is obtained by an element analysis such as X-ray photoelectron spectrometry, an appropriate substance is applied to the formula (3) as the substance of the core in the X-ray waveguide, and the refractive index real part of the substance for the X-ray can be calculated.

### (Outline Constitution of X-Ray Waveguide)

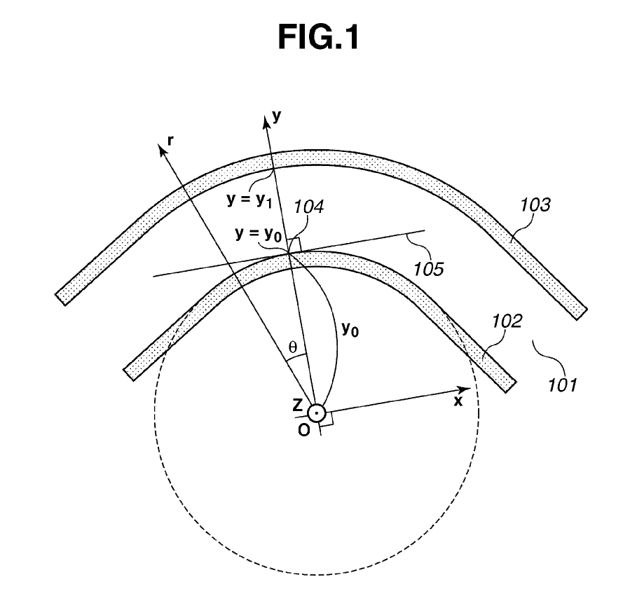

FIG. 1 is a view illustrating an outline constitution of the X-ray waveguide of the present embodiment, and shows a cross-section when the X-ray waveguide is cut in a waveguiding direction of the X-ray.

The X-ray waveguide having the curved structure of the present embodiment has a core 101 and two claddings, cladding A 102 and cladding B 103 that sandwich the core and are mutually opposed.

Here, the X-ray waveguide having the curved structure has a region having the curved structure formed of the cladding A 102, the cladding B 103 that are two claddings, and the core 101. Typically, the cladding A 102, the cladding B 103, and the core 101 configure the curved structure.

Even if the core 101 is filled with gas, when a space formed of the cladding A 102 and the cladding B 103 (e.g., core 101) has the curved structure, an expression that the core 101 has the curved structure, is used. In other words, when the core is completely filled with a material such as a polymer material having a shape, if an object formed of the filled material having the shape has the curved structure, an expression that the core 101 has the curved structure can also be used.

The X-ray waveguide having the curved structure of the present embodiment may have also a region having no curved structure as the other region as long as it has the region having the curved structure formed of the cladding A 102, the cladding B 103, and the core 101.

The X-ray waveguide having the curved structure of the present embodiment is an X-ray waveguide having a curved structure formed of a core and two claddings that sandwich the core and are mutually opposed. A y-axis is defined, by using as an origin a center of a circle which defines a curvature radius of an interface between a cladding A present on an inner circumference side of the curved structure of the two claddings, and the core, in a direction perpendicular to a tangent 105 at any point S 104 on the interface, and from the origin toward the interface. As to any y that satisfies the following formula (7), the refractive index real part n(y) of the core satisfies the following formulae (5) and (6):

ñ(y₀)>ñ(y₁) Formula (5)

ñ(y₀)≧ñ(y)≧ñ(y₁) Formula (6)

y₀<y<y₁ Formula (7)

wherein in Formula (5), y₀ is a y-coordinate of the interface between the core and the cladding A, y₁ is a y-coordinate of the interface between the core and a cladding B present on an outer circumference side of the two claddings, n(y₀) denotes the refractive index real part of the core at the y₀, and n(y₁) denotes the refractive index real part of the core at the y₁.

This means that the refractive index real part of the core 101 decreases as y increases in any region within a range of y₀ or more, and y₁ or less on the y-coordinate.

As long as the refractive index real part of the core 101 decreases as y increases in any region within the range between y₀ or more, and y₁ or less on the y-coordinate, the refractive index real part in the other region can be equal even if y increases.

In the course that “the refractive index real part of the core 101 decreases as y increases in any region within the range between y₀ or more and y₁ or less on the y-coordinate”, the refractive index real part continuously decreases (monotonic decrease) or decreases in a step-by-step manner. “Decreasing in a step-by-step manner” described here refers to, for example, the case where the refractive index real part is C when y is in the range between A or more and B or less, and the refractive index real part is E when y is between more than B and D or less.

Of the two claddings, the cladding present on the outer circumference side refers to the one corresponding to an incircle having a larger radius when incircles tangent to each of the two claddings are assumed. The cladding present on the inner circumference side refers to the one corresponding to an incircle having a smaller radius when incircles tangent to each of the two cladding are assumed.

As described later, characteristics of the X-ray wave guide such as an X-ray intensity distribution and a propagation loss in the waveguide can be obtained by calculating a waveguide mode (eigenvalue calculation). The calculation of the waveguide mode can be carried out by a calculation technique such as a finite element method from a wave equation that defines the X-ray waveguide. The distribution of the refractive index real part of the core 101 that composes the X-ray waveguide of the present embodiment and the refractive index real parts of the claddings A 102 and B 103 can appropriately be designed using the calculation of waveguide mode.

As a constitution in which the refractive index real part of the core 101 decreases in a step-by-step manner, for example, the core 101 has a plurality of regions in a positive direction on the y-axis and the regions are located in the order that the refractive index real part of the region decreases along the positive direction on the y-axis.

When the core 101 has two regions, the two regions may be located across a central axis (in other words, an axis connecting points of (y₁−y₀)/2 with respect to the y-axis obtained by moving the aforementioned point S). Alternatively a region from an interface between the core and the cladding A to ¼ of entire thickness of the core may be one region and a rest region may be the other region. Alternatively, a region from the interface between the core and the cladding A to ¾ of entire thickness of the core may be one region and a rest region may be the other region.

Such a constitution can be realized by, for example, forming the aforementioned regions with materials having the different refractive index real part.

When the core 101 is composed of a mixture of a first material and a second material having the smaller refractive index real part than that of the first material and the second material shows a distribution represented by an increasing function of y in the core 101, it can also be configured such that the refractive index of the core 101 continuously decreases along with an increase of y in any region between y₀ or more and y₁ or less on the y-axis.

Further, that “the refractive index real part n(y) of the core satisfies the formulae (5) and (6) as to any y that satisfies the formula (7)” means that the refractive index real part n(y) of the core satisfies the formulae (5) and (6) as to all y that satisfy the formula (7).

The curvature radius described here is the curvature radius of the interface between the core 101 and the cladding A 102 and is represented by y₀ in FIG. 1.

When a curved optical element such as the X-ray waveguide having the curved structure of the present embodiment is used, it is convenient that a wave equation of the X-ray waveguide is described by using a cylindrical coordinate system (rθz coordinate system), which is then converted into an Cartesian coordinate system (xyz coordinate system). When the wave equation described by the cylindrical coordinate system is converted into the Cartesian coordinate system, a formula (8) is derived.

$$\frac{{\partial }^{2} E}{\partial {z}^{2}} + \frac{{\partial }^{2} E}{\partial {y}^{2}} + {{k}_{0}^{2} ( {n}_{0} ( y ) {e}^{\frac{y - {y}_{0}}{{y}_{0}}} )}^{2} = {{β}^{2} ( {e}^{\frac{y - {y}_{0}}{{y}_{0}}} )}^{2} E \qquad Formula 8$$

wherein K₀: wavenumber of X-ray, n₀: refractive index, β: propagation constant of X-ray waveguide, and E: electric field of X-ray.

Arrangements of the cylindrical coordinate system and the Cartesian coordinate system are as shown in FIG. 1, and both coordinate systems are using a point O as the origin. When y₀ is sufficiently larger than y-y₀, exp[(y−y₀)/y₀] of the formula (8) on a right-hand side can be approximated to 1. Thus, the curved X-ray waveguide is equivalent to an uncurved X-ray waveguide (X-ray waveguide in which the X-ray is propagated along an x-axis and the cross-section of the X-ray waveguide is a yz-plane) in which the refractive index n is modulated as shown in a following formula (9).

$$n ( y ) = {n}_{0} ( y ) {e}^{\frac{y - {y}_{0}}{{y}_{0 }}} \qquad Formula ( 9 )$$

In the case of the X-ray waveguide, the curvature radius y₀ is a 1 mm-order at a minimum while a width of the core 101 is a 100 nm-order at a maximum. Thus, the approximation can be applied here in this range.

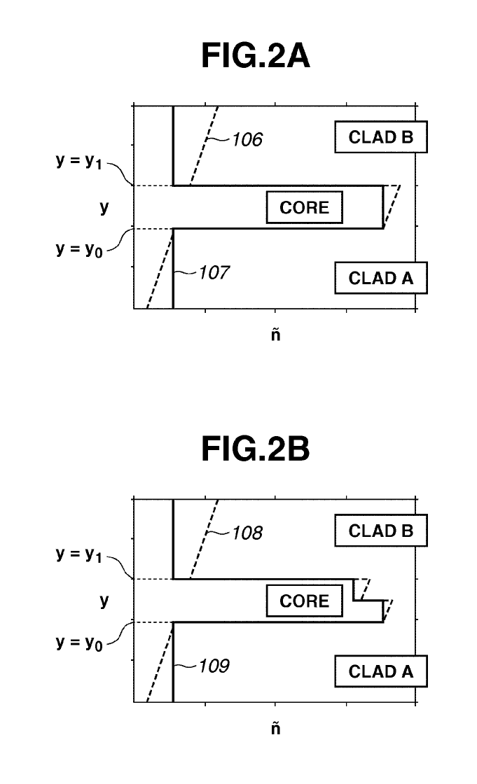

FIG. 2A shows the distribution of the refractive index real part of the X-ray waveguide having the conventional curved structure in which the refractive index of the core is uniform and which is converted into the Cartesian coordinate system having no curved structure by the formula (9), and the distribution of the refractive index real part of the X-ray waveguide in which the refractive index of the core is uniform and which has no conventional curved structure. A dot line 106 represents the distribution of the refractive index real part of the X-ray waveguide having the conventional curved structure in which the refractive index of the core is uniform and which is converted into the Cartesian coordinate system. A solid line 107 represents the distribution of the refractive index real part of the X-ray waveguide in which the refractive index of the core is uniform and which has no curved structure.

A value of the refractive index real part of the core in the X-ray waveguide having the curved structure is larger than the X-ray waveguide having no curved structure in the range of y₀<y<y₁. Further, as y becomes larger, the value of the refractive index real part increases. In this way, when the value of the refractive index real part has the distribution in the core, the X-ray generally concentrates on the region in which the refractive index real part is large (waveguiding loss is small). Thus, the X-ray sometimes concentrates and leaks in the proximity of the interface between the core and the cladding on the outer circumference side in the X-ray waveguide having the curved structure.

That is, when the curvature radius of the waveguide having the curved structure is reduced, the refractive index real part of the core on the outer circumference side increases according to the formula (9), and the X-ray sometimes leaks toward the cladding on the outer circumference side. Thus, it becomes necessary to increase the curvature radius to some extent.

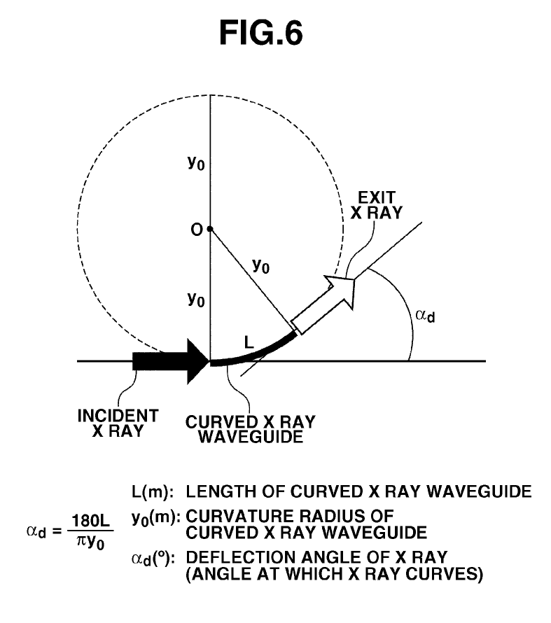

Conventionally, it is necessary to make the curvature radius 0.1 m or more, thereby increasing the deflection angle (α_{d}, see FIG. 6). Thus, it becomes necessary to lengthen the X-ray waveguide, and the deflection angle is restricted to 2°.

FIG. 2B shows the distribution of the refractive index real part of the X-ray waveguide having the curved structure in which the aforementioned core has the refractive index distribution and which is converted into the Cartesian coordinate system having no curved structure, by the formula (9), and the distribution of the refractive index real part of the X-ray waveguide having no curved structure although the core has the similar refractive index distribution.

A dot line 108 denotes the distribution of the refractive index real part of the X-ray waveguide having the curved structure in which the aforementioned core has the refractive index distribution and which is converted into the Cartesian coordinate system having no curved structure. A solid line 109 denotes the distribution of the refractive index real part of the X-ray waveguide having no curved structure although the core has the refractive index distribution.

As shown with the dot line 108 in FIG. 2B, by making the refractive index real part in the region of larger y, smaller than the refractive index real part in the region of the smaller y, the X-ray guided to the interface between the core and the cladding on the outer circumference side is induced in the X-ray waveguide having the curved structure. Thus, it becomes difficult for X-ray to leak from the cladding on the outer circumference side. That is, the X-ray waveguide has a smaller propagation loss coefficient (the imaginary part of the propagation coefficient in the formula (8)) than conventional ones.

The deflection angle α_{d} is an increasing function of a length L of the X-ray waveguide and a decreasing function of the curvature radius y₀ as described in FIG. 6. Meanwhile, when L is increased, the propagation loss of the X-ray is increased.

In the X-ray waveguide of the present embodiment, even if the X-ray waveguide has the curved structure, the curvature radius can be reduced while a waveguiding loss coefficient is reduced. Thus, it is not necessary to lengthen the length L of the X-ray waveguide and the deflection angle of the X-ray can be made larger than conventional ones.

Next, each part of the X-ray waveguide of the present embodiment will be described.

### (Core)

In the core, its refractive index real part n(y) satisfies the aforementioned formulae (5) and (6) as to any y that satisfies the aforementioned formula (7).

When the refractive index real part decreases in a step-by-step manner, it is necessary to control a decreasing rate of the refractive index real part and a size of the decreased region. The appropriate decreasing rate of the refractive index real part according to the curvature radius and the like, and the size of the region can be determined by evaluating the propagation loss (linear absorption coefficient) of a theoretical waveguide mode obtained by the calculation technique such as the finite element method and an X-ray intensity distribution formed in the waveguide.

It is desirable to use a material having an absorption loss of X-ray, which is as small as possible, for such a core. For example, such a core can be formed of gas such as vacuum and air and an organic matter such as a polymer.

The core can be formed by a conventional method, for example, a dry process such as sputtering, vapor deposition or a chemical vapor deposition method (CVD). When the core composed of a polymer such as polyimide or polystyrene is formed, a solution in which such a polymer is dissolved can be coated by a method such as spin coating or dip coating. When the X-ray waveguide in which the refractive index real part of the core continuously decreases is formed, it is desirable to use the sputtering, the vapor deposition or CVD.

When the gas such as the air is used for the core, a width of the core may be set to an appropriate value using a piezo actuator by adjusting a position of the cladding A or the cladding B.

### (Cladding)

The cladding is composed of a material, in which the refractive index real part is smaller than the refractive index real part of the core in the interface between the core and cladding.

For example, when carbon, the organic matter such as polymer, or the gas is used for the core in the interface between the core and the cladding, tantalum, tungsten, gold, silicon, and the like can be used for the cladding.

Any of conventionally known methods can be used for forming the cladding as is the case with the core, but it is desirable to form it by the dry process such as the sputtering and the vapor deposition because a flat interface with the core can be formed.

In the present invention, as long as the cladding A and the cladding B are mutually opposed as shown in FIG. 1, both may be connected to each other. For example, in the case of the two dimensional trapping waveguide as described later, the claddings continuously surround the core, and when the cladding A is defined, an opposed side is defined as the cladding B. In such a case, the cladding can have a cylindrical shape, an elliptic cylindrical shape, or the like.

### (Relation Between Core and Claddings)

In the X-ray waveguide of the present embodiment, the X-ray is trapped in the core to guide an X-ray wave by total reflection in the interface between the core and the claddings. In order to realize the total reflection, the refractive index real part of the core is formed larger than the refractive index real part of the cladding in the X-ray waveguide. This condition must be satisfied also when the X-ray waveguide having the curved structure is converted into the X-ray waveguide having no curved structure.

In the present embodiment, as long as the effect of the present invention is not lost, a layer including a material different from a major material of the core, in which the refractive index real part is larger or smaller than the refractive index real part of the major material of the core may be present in the interface between the core and cladding. Examples of such a layer include an air layer and a flattening layer. Such a layer is included in the core. An interface between such a layer and the cladding A 102 and an interface between such a layer and the cladding B 103 are defined as y₀ and y₁, respectively.

### (Trapping Dimension)

A structure in which the X-ray of the X-ray waveguide having the curved structure of the present embodiment is confined may be a one-dimensional structure in which a film-shaped core is sandwiched by the claddings, or a two-dimensional structure in which the core having a circular or rectangular cross section perpendicular to a waveguiding direction is surrounded with the claddings. In the X-ray waveguide having the two-dimensional structure, the X-ray is confined two-dimensionally in the waveguide. Thus, a divergence of the X-ray is further suppressed compared with the one dimensional structure, and a spot-like X-ray having a small beam size can be isolated.

A lithography process can be used for making the X-ray waveguide of the two-dimensional confinement type.

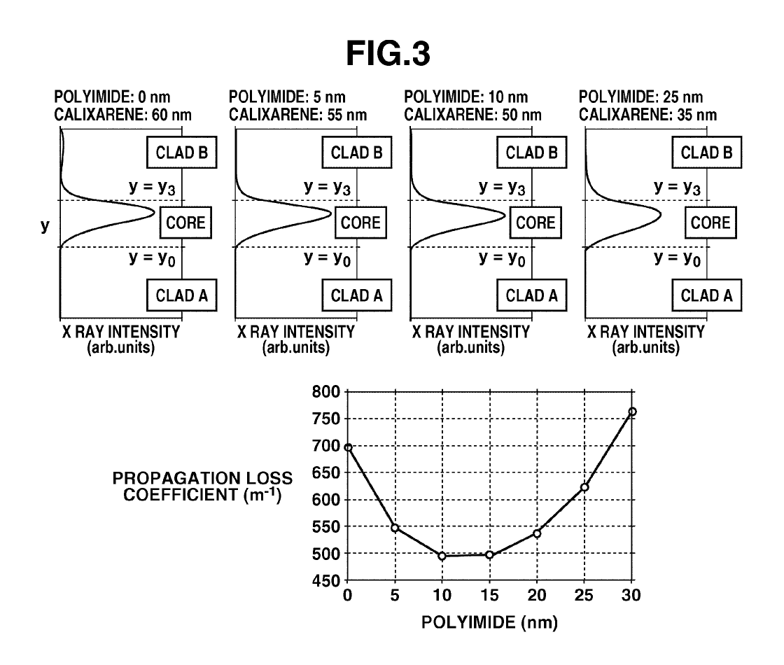

FIG. 3 shows results of simulation experiments performing the eigenvalue calculation of the wave equation of the formula (8) concerning the waveguide mode and its propagation loss coefficient of the curved X-ray waveguide of the present invention, in which the claddings A 102 and B 103 are composed of silicon and the core is composed of calixarene and polyimide, as an example. This is the example of the curved X-ray waveguide, in which calixarene having the larger refractive index real part is arranged in the interface between the core 101 and the cladding A 102, polyimide having the smaller refractive index real part is arranged in the interface between the core 101 and the cladding B 103, further an entire thickness of the core 101 is 60 nm, and the curvature radius is 0.05 m (X-ray energy: 12 keV). It is found that the X-ray intensity distribution formed in the waveguide is changed and the propagation loss is changed by changing the thickness of the polyimide layer. It is found that when the thickness of the polyimide layer is 10 nm and the thickness of the calixarene layer is 50 nm, the propagation loss is lower compared with the other cases, and it is also found that with respect to the X-ray intensity distribution, the X-ray does not leak so much into the cladding B 103.

As described above, by performing the eigenvalue calculation of the wave equation of the X-ray waveguide using the calculation technique such as the finite element method, it is possible to appropriately design the X-ray waveguide of the present invention in a desirable form as to the refractive index distribution of the core and selection of a material having such refractive index distribution.

### (X-Ray System and Apparatus)

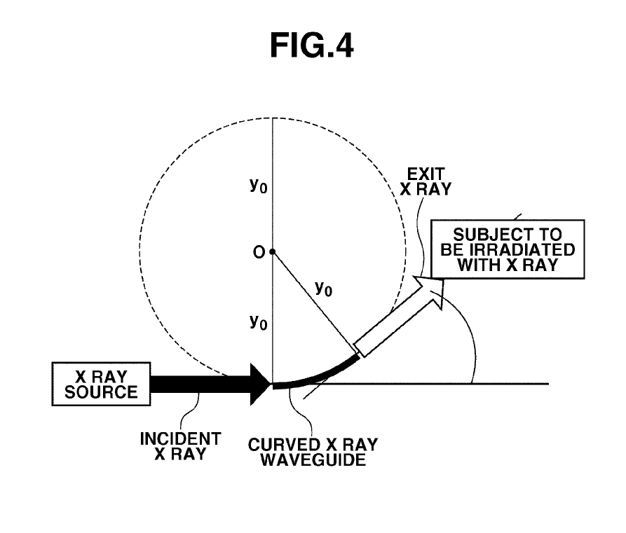

FIG. 4 shows the X-ray system and apparatus of the present embodiment. An incident X-ray is emitted from an X-ray source to a curved X-ray waveguide, the X-ray is guided in the curved X-ray waveguide of the present embodiment, and a subject to be irradiated with the X-ray is irradiated with the X-ray that exits from its end edge. An X-ray generation apparatus such as a synchrotron or Coolidge tube, or a fluorescent X-ray from a material object can be used as the X-ray source. Subjects to be analyzed by the X-ray and imaging subjects to be processed in holography and the like can be as an example subjects to be irradiated with the X-ray.

Hereinafter, the present invention will be described in more detail with reference to exemplary embodiments, but the present invention is not limited thereto.

A first exemplary embodiment of the present invention is a curved X-ray waveguide of the present invention, in which tungsten is used for claddings A 102 and B 103 and carbon and B₄C are used for a core 101. This exemplary embodiment is also an X-ray system in which a synchrotron is used as the X-ray source and a two dimensional X-ray detector is used as a subject to be irradiated with the X-ray.

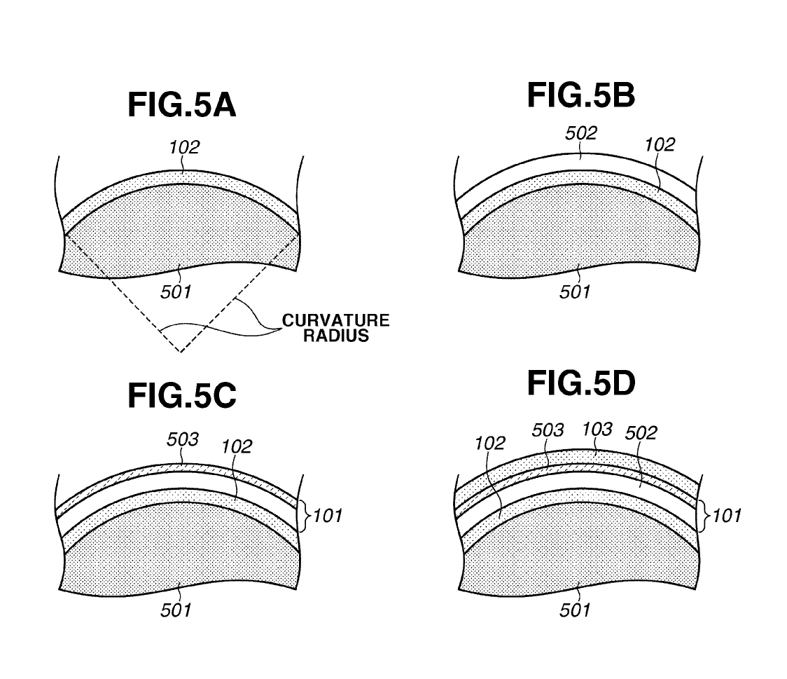

The curved X-ray waveguide of this exemplary embodiment is produced by a sputtering method including the following steps (FIGS. 5A-5D).

### (a) Formation of Cladding A 102

A film of tungsten (cladding A) 102 having a thickness of 20 nm is formed on a glass base material 501 having a cylindrical curved convex surface of a 0.01 m curvature radius, using a magnetron sputtering method (FIG. 5A).

### (b) Formation of Core 101

A film of carbon 502 having a thickness of 80 nm is formed on the tungsten film (cladding A) 102 by the magnetron sputtering method (FIG. 5B), and subsequently a film of B₄C 503 with a refractive index real part smaller than carbon for the X-ray of 10 keV and having a thickness of 20 nm is formed thereon (FIG. 5C). A portion in which carbon is combined with B₄C is the core 101.

A part of the glass base material 501 on which the core 101 has been formed is cut out, and an element distribution in a y-axis direction of the core 101 is analyzed using an X-ray photoelectron analyzer while the core 101 is irradiated with argon ion beam and its surface is gradually ground down. It can be confirmed that the distribution of the refractive index real part of the core 101 obtained from the resulting element distribution by using the Formula (5) decreases along with an increase of y at y=y₀+80 nm.

### (c) Formation of Cladding B 103

A film of tungsten (cladding B) 103 having a thickness of 20 nm is formed by the magnetron sputtering method, by covering the core 101 to produce a one dimensional trapping X-ray waveguide (FIG. 5D).

### (d) Determination of Length of Curved X-Ray Waveguide

The glass base material 501 on which the waveguide has been formed is cut using a dicing apparatus. At that time, a plurality of samples in which the length of the curved X-ray waveguide is different is obtained.

A waveguiding property of the obtained curved X-ray waveguide is evaluated using an incident X-ray of 10 keV obtained by a synchrotron and a two dimensional X-ray detector. The incident X-ray of 10 keV is entered from an edge part of the curved X-ray waveguide, and an interference pattern formed at backward of the waveguide (camera length: 1500 mm) by the guided X-ray emitted from the end edge of the waveguide (exit X-ray) is measured using the two dimensional X-ray detector.

A deflection angle of the X-ray defined in FIG. 6 is made 5° by using a sample of the 0.01 m curvature radius and the 0.9 mm long curved X-ray waveguide, and the guided X-ray (exit X-ray) can be detected. This is because even if the curved X-ray waveguide has the smaller curvature radius than conventional ones, the waveguiding of the X-ray with sufficiently low loss can be realized.

A second exemplary embodiment of the present invention is a curved X-ray waveguide, in which tungsten is used for the claddings A 102 and B 103, and polystyrene and air are used for the core 101. Two-dimensional X-ray detector is used as the subject to be irradiated with the X-ray.

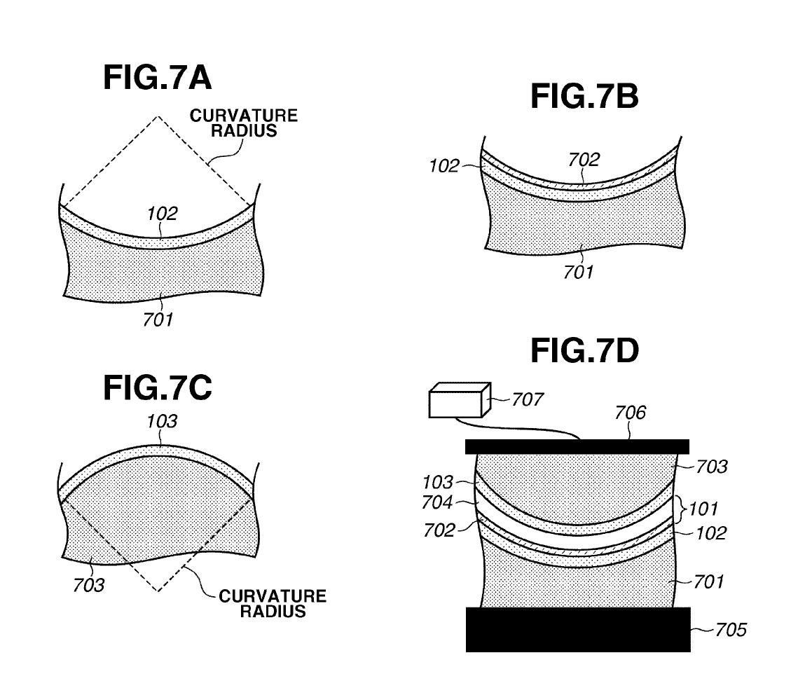

The curved X-ray waveguide of this exemplary embodiment is produced by a sputtering method or a dip coating method including the following steps (FIGS. 7A-7D).

### (a) Formation of Cladding A 102

A film of tungsten (cladding A) 102 having a thickness of 20 nm is formed on a glass base material 701 having a cylindrical curved concave surface, the curvature radius of which is 0.01 m, by using the magnetron sputtering method (FIG. 7A).

### (b) Formation of Part of Core 101

A solution in which polystyrene has been dissolved is applied onto the tungsten film (cladding A) 102 by dip coating to form a polystyrene layer 702 having a thickness of 15 nm (FIG. 7B). The polystyrene layer 702 composes a part of the core 101.

### (c) Formation of Cladding B 103

A film of tungsten (cladding B) 103 having a thickness of 20 nm is formed on a glass base material 703 having a cylindrical curved convex surface, the curvature radius of which is 0.01 m, by using the magnetron sputtering method (FIG. 7C).

### (d) Production of Waveguide Structure and Determination of Length of Curved X-Ray Waveguide

The glass base material 701 on which the tungsten film 102 and the polystyrene layer 702 have been formed and the glass base material 703 on which the tungsten film 103 has been formed are cut using the dicing apparatus. At that time, a plurality of samples showing the different length of the curved part is obtained.

The glass base material 701 and the glass base material 703 which have the curved parts of the same length are mutually opposed to produce a curved X-ray waveguide (FIG. 7D). The glass base material 701 is fixed to a sample stage 705 and the glass base material 703 is fixed to a stage which can be driven by a piezo actuator. The piezo actuator is driven by a controller 707 to adjust an angle and a position, and the stage 706 is fixed so that a gap (interval) 704 between the tungsten film 103 and the polystyrene layer 702 is 45 nm. The polystyrene layer 702 is combined with the air that composes the gap 704 to make the core 101 having a thickness of 60 nm.

A waveguiding property of the obtained curved X-ray waveguide is evaluated using the incident X-ray of 10 keV obtained by a synchrotron, and the two dimensional X-ray detector. The incident X-ray of 10 keV is entered from the edge part of the curved X-ray waveguide, and the interference pattern formed at backward of the waveguide (camera length: 1500 mm) by the guided X-ray emitted from the end edge of the waveguide (exit X-ray) is measured using the two-dimensional X-ray detector.

A deflection angle of the X-ray defined in FIG. 6 is made 20° by using a sample in which the curvature radius is 0.01 m and the length of the curved X-ray waveguide is 3.5 mm, and the guided X-ray (exit X-ray) can be detected. This is because even if the curved X-ray waveguide has the smaller curvature radius than conventional ones, the waveguiding of the X-ray with sufficiently low loss can be realized. In this exemplary embodiment, polystyrene and the air in which the absorption loss of the X-ray is smaller than in other exemplary embodiments are used for the core 101. Thus, the loss of guided X-ray is extremely small and the X-ray waveguide can be relatively lengthened. Thus, the deflection angel of the X-ray can be increased.

A third exemplary embodiment of the present invention is a curved X-ray waveguide, in which silicon is used for the claddings A 102 and B 103 and calixarene and silicon are used for the core 101. This exemplary embodiment is an X-ray system in which a synchrotron is used as an X-ray source and the two dimensional X-ray detector is used as a subject to be irradiated with the X-ray.

The curved X-ray waveguide of this exemplary embodiment is produced by a vapor deposition method, a sputtering method or a spin coating method including the following steps.

### (a) Formation of Cladding A 102

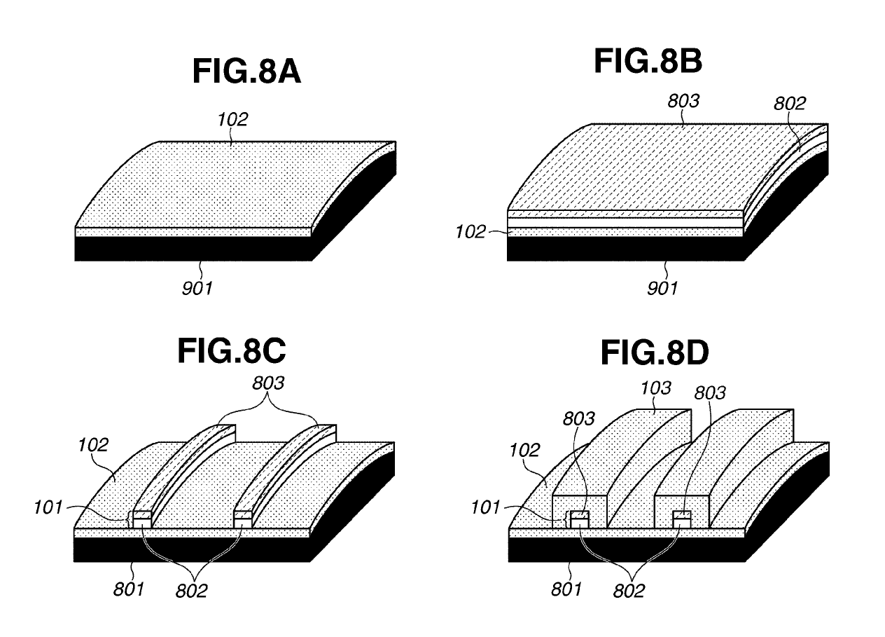

A film of silicon (cladding A) 102 having a thickness of 50 nm is formed on a glass base material 801 having a cylindrical curved convex surface which shows the curvature radius of 0.05 m, by the vapor deposition method (FIG. 8A).

### (b) Formation of Core 101

A solution in which calixarene has been dissolved is applied onto the silicon film (cladding A) 102 by the spin coating method to form a calixarene layer 802 having a thickness of 50 nm. A carbon layer 803 with the refractive index real part of 12 keV X-ray which is smaller than the calixarene layer, and having a thickness of 10 nm is formed thereon by the magnetron sputtering. The calixarene layer 802 and the carbon layer 803 compose the core 101 (FIG. 8B).

A part of the glass base material 801 on which the core 101 has been formed is cut out, and an element distribution in the y-axis direction of the core 101 is analyzed using the X-ray photoelectron analyzer while the core 101 is irradiated with argon ion beam and its surface is gradually ground down. It can be confirmed from the resulting element distribution that the distribution of the refractive index real part of the core 101 obtained using the Formula (5) decreases with the increase of y at y=y₀+50 nm.

### (c) Processing of Core 101

The core 101 of a line pattern having a width of 60 nm is formed along a curved direction of the glass base material at intervals of 500 nm using the lithography method disclosed in C. Fuhse, “X-ray waveguides and waveguide-based lensless imaging” (FIG. 8C)

### (d) Formation of Cladding B 103

A silicon film (cladding B) 103 having a thickness of 50 nm or more is formed by the vapor deposition method and covers the core 101 and the cladding A 102 to make a two dimensional trapping X-ray waveguide (FIG. 8D).

### (e) Determination of Length of Curved X-Ray Waveguide

The glass base material 801 on which the waveguide has been formed is cut using the dicing apparatus. At that time, a plurality of samples including the curved X-ray waveguides of different length is obtained.

A waveguiding property of the obtained curved X-ray waveguide is evaluated using an incident X-ray of 12 keV obtained by a synchrotron, and the two dimensional X-ray detector. The incident X-ray of 12 keV is entered from the edge part of the curved X-ray waveguide, and the interference pattern formed at backward of the waveguide (camera length: 1500 mm) by the guided X-ray emitted from the end edge of the waveguide (exit X-ray) is measured using the two dimensional X-ray detector. By using a sample in which the curvature radius is 0.05 m and the length of the curved X-ray waveguide is 3 mm, a deflection angle of the X-ray defined in FIG. 6 is made 3.4° and the guided X-ray (exit X-ray) can be detected. This is because even if the curved X-ray waveguide has the smaller curvature radius than conventional ones, the waveguiding of the X-ray with sufficiently low loss can be obtained and the longer waveguide can be used. In the waveguide in which only the calixarene layer having a cross section of 60 nm square constitutes the core 101, the guided X-ray cannot be detected in a case of a sample in which the curvature radius is 0.05 m and the length of the curved X-ray waveguide is 3 mm.

The X-ray waveguide according to the present invention can provide the X-ray showing coherent phases, further can curve the X-ray to adjust the direction, and is useful for analysis technology and imaging techniques using the X-ray.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-182266 filed Aug. 21, 2012, which is hereby incorporated by reference herein in its entirety.

What is claimed is:

1. An X-ray waveguide having a curved structure formed of a core and two claddings that sandwich the core and are mutually opposed,
wherein when a y-axis is defined using as an origin a center of a circle which defines a curvature radius of an interface between a cladding A present on an inner circumference side of the curved structure of the two claddings, and the core, in a direction perpendicular to a tangent at an arbitrary point S on the interface and in a direction from the origin toward the interface, as to any y that satisfies a following formula (7), a refractive index real part n(y) of the core satisfies following formulae (5) and (6):
ñ(y₀)>ñ(y₁) Formula (5)
ñ(y₀)≧ñ(y)≧ñ(y₁) Formula (6)
y₀<y<y₁ Formula (7)
wherein in Formula (5), y₀ is a y-coordinate of the interface between the core and the cladding A, and y₁ is a y-coordinate of the interface between the core and a cladding B present on an outer circumference side of the two claddings, and n(y₀) denotes a refractive index real part of the core at the y₀, and n(y₁) denotes a refractive index real part of the core at the y₁.

2. The X-ray waveguide according to claim 1, wherein the core is composed of a mixture of a first material and a second material with a refractive index real part smaller than the first material, and
wherein the second material is distributed within the core, whose quantity is indicated by an increasing function of y.

3. The X-ray waveguide according to claim 1, wherein the two claddings are connected and form a cylindrical shape or an elliptic cylindrical shape.

4. An X-ray waveguide having a curved structure formed of a core and two claddings that sandwich the core and are mutually opposed,
wherein the two claddings are composed of a cladding A present on an inner circumference side of the curved structure and a cladding B present on an outer circumference side of the curved structure
wherein the core has a plurality of regions along a direction from the cladding A toward the cladding B, and
wherein the plurality of regions is located along the direction in the order that a refractive index real part decreases.

5. The X-ray waveguide according to claim 4, wherein the plurality of regions is two regions.

6. The X-ray waveguide according to claim 5, wherein the two regions are composed of different materials respectively.

7. An X-ray measurement system comprising an X-ray source that generates an X-ray and the X-ray waveguide according to claim 1, which guides the X-ray toward an object to be measured.

8. An X-ray measurement apparatus comprising an X-ray source that generates an X-ray and the X-ray waveguide according to claim 1, which guides the X-ray toward an object to be measured.

9. An X-ray measurement system comprising an X-ray source that generates an X-ray and the X-ray waveguide according to claim 4, which guides the X-ray toward an object to be measured.

10. An X-ray measurement apparatus comprising an X-ray source that generates an X-ray and the X-ray waveguide according to claim 4, which guides the X-ray toward an object to be measured.
